(19) United States
(12) Patent Application Publication
(10) Pub. No.: US 2019/0359532 A1
(43) Pub. Date: Nov. 28, 2019

(54) SURFACE ROUGHENING OF CMC AND COATED CMC

(71) Applicant: Siemens Aktiengesellschaft, MÜNCHEN (DE)

(72) Inventors: Niels Van der Laag, Vaterstetten (DE); Arturo Flores Renteria, Berlin (DE); David J. Mitchell, Oviedo, FL (US)

(21) Appl. No.: 16/348,519

(22) PCT Filed: Nov. 7, 2017
(86) PCT No.: PCT/EP2017/078459

§ 371 Date: May 9, 2019

(30) Foreign Application Priority Data
Nov. 14, 2016 (EP) 16198638.5

(51) Int. Cl. C04B 41/00; B23K 26/0622; B23K 26/352; C04B 41/53; C04B 41/91; C04B 41/50; C04B 41/87

(52) U.S. Cl. CPC C04B 41/0036; B23K 26/0624; B23K 26/3584; C04B 41/009; B23K 2103/16; C04B 41/91; C04B 41/5042; C04B 41/5031; C04B 41/87; C04B 41/5346

(57) ABSTRACT

By surface roughening of CMC component via a pico-laser treatment a good adhering of a plasma sprayed coating is achieved.

### CROSS-REFERENCE TO RELATED APPLICATIONS

This application claims priority to PCT Application No. PCT/EP2017/078459, having a filing date of Nov. 7, 2017, which is based on European Application No. 16198638.5, having a filing date of Nov. 14, 2016, the entire contents both of which are hereby incorporated by reference.

### FIELD OF TECHNOLOGY

The following relates to a surface roughening of a CMC part which will be coated with a ceramic layer.

### BACKGROUND

Oxide based Ceramic Matrix Composites (CMC's) provide a higher temperature capability (1423K) than superalloys 1273K C) and superior oxidation resistance. The limited fracture resistance and damage tolerance of ceramic materials is substantially improved by the fiber reinforcement. However, the load bearing capacity (mechanical strength) of these Oxide-Oxide (Ox-Ox) CMCs is also limited by grain growth and reaction processes with the matrix and/or the environment at 1423K and higher. With firing temperatures as high as 1873 1973K, Ox-Ox CMCs need Environmental Barrier Coatings (EBCs) that maintain CMCs below 1423K. Thus, CMCs can be used to its full potential, only if the coating can be integrated in to the system design.

For oxide-oxide CMCs, application of the thermal barrier was by an FGI (Friable Graded Insulation) system. FGI was coprocessed along with CMC, however, currently the hollow spheres needed for this coating system are not commercially available. In addition, the capability of the coating to recession at high surface temperatures (1873K-1973K) is not expected to match behavior of zirconia-based materials.

### SUMMARY

The current proposal takes into account the experience of using proper roughening of the substrate surface for TBC adhesion.

The description and the figure are only examples of embodiments of the invention.

Application of plasma sprayed coating on CMC surface is not easy. Depending upon the local macro roughness of the ceramic fibers and matrix infiltration characteristics, the adhesion of plasma sprayed coatings are poor. Plasma sprayed coating don't adhere well to CMC surfaces especially on the surface of in-plane fibers direction.

The proposed embodiments provide significant improvements in the ability for plasma sprayed coatings to adhere to the CMC substrate.

Better adhesion is achieved by increasing mechanical interlocking via surface roughening of the CMC by using pico-laser machining. This technology allows the grinding of the CMC surface in a better controlled way compared to standard grit-blasting processing or as received conditions. Moreover, the pico-laser avoids the glassing of the ceramic material surface by its capability of almost fully evaporate the CMC during machining.

The inventive step is the use of pico-laser to prepare the CMC surface in the out of plane configuration prior to the APS coating process enhancing the engineering capability of the surface preparation compared to standard processes like grit blasting.

Furthermore, no extra phases are introduced into the top region of the CMC due to the capability of pico-laser machining to overcome glassing. This allows an improved chemical bonding with the EBC without a potentially weak glassy interlayer. Additionally, it allows an enhanced shape of the roughness (macro- and micro roughness of hills and valleys).

### BRIEF DESCRIPTION

Some of the embodiments will be described in detail, with references to the following Figures, wherein like designations denote like members, wherein:

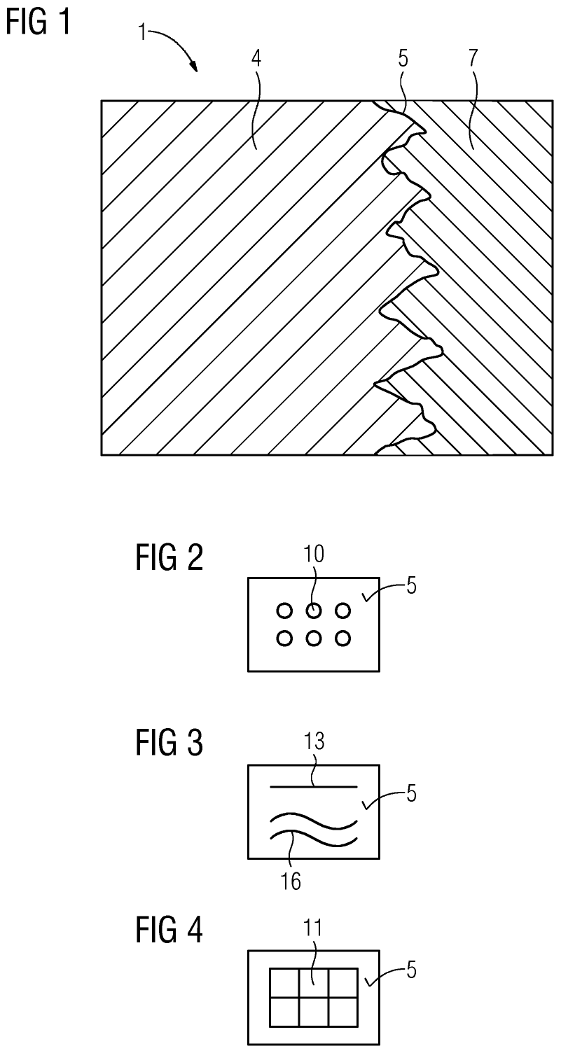

The FIG. 1 shows a CMC component 1 which comprises a CMC substrate 4 with a surface 5.

### DETAILED DESCRIPTION

The substrate 4 is made of a CMC, of an Ox-Ox-CMC, but not limited.

As described above the surface 5 of the CMC-substrate 4 is roughened or structured by a pico-laser, which leads to no melting of the material of the CMC. Pulses in the pico-second region are used, especially max 900 ps.

The surface 5 of the CMC-substrate 4 can comprise holes 10 (FIG. 2), especially round holes, elongated engravings 13, 16 (FIG. 3), which can be straight 13 or waved 16 or grids 11 (FIG. 4). These forms 10, 13, 16, 11 can appear alone or in combination with each other in the surface 5.

An alternative is to randomly remove locally material from the surface to roughen the surface 5 deeper and additionally (FIG. 5).

Especially a depth of 50 μm to 100 μm is at least given for the holes 10, engravings 13, 16 or grids 11.

After that a ceramic layer 7 is applied on which is performed by APS.

The material of the ceramic layer 7 is zirconia (ZrO₂), stabilized zirconia 8YSZ and/or an alumina sublayer, or alumina or 48YSZ (fully stabilized zirkonia).

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method of roughening a surface of a CMC substrate of a CMC component, wherein a pico-laser with pulses in the pico-second area is used to roughen or engrave the surface of the CMC substrate.

2. The method according to claim 1, wherein holes, including at least one of round holes, engravings, and grids are produced into the surface of the CMC substrate.

3. A product, produced by a method according to claim 1, which has a ceramic layer on a roughened surface of a substrate, wherein the ceramic layer has a APS applied-like microstructure.

4. The product according to claim 3, wherein the material of the ceramic layer comprises zirconia, 8YSZ, alumina, 48YSZ or a 48YSZ-alumina mixture.

5. The product according to claim 3, wherein the surface of the substrate under the ceramic layer comprises holes, especially including at least one of round holes, elongated engravings, and grids.

6. The product according to claim 5, wherein the depth of the holes 10, engravings or grids are between 50 μm to 100 μm.
